(19) United States
(12) Patent Application Publication
(10) Pub. No.: US 2007/0159930 A1
(43) Pub. Date: Jul. 12, 2007

(54) Thumb anchored watch for runners

(76) Inventor: Donald Montgomery, White Lake, MI (US)

Correspondence Address: EDWIN TARVER, 16830 Ventura Blvd., SUITE 360, Encino, CA, 91436, US

(21) Appl. No.: 11/651,905

(22) Filed: Jan. 8, 2007

Related U.S. Application Data
(60) Provisional application No. 60/756,660, filed on Jan. 6, 2006.

(51) Int. Cl. G04B 37/00; A44C 5/00

(52) U.S. Cl. 368/281

(57) ABSTRACT

An improved watch for sports personnel which comprises a watchcase, a wrist loop extending from one side of case and a thumb loop extending from opposite side of the case. The watchcase houses a watch mechanism, a display and control buttons. The watch can be worn by a user by inserting hand in the wrist loop and thumb in the thumb loop, such that the watchcase rests on the knuckle of the thumb. This allows the user to see the display without turning hand, thereby preventing the distraction caused by turning hand to view the time during running. The loops are made of flexible materials and are adjustable to accommodate different wrists and thumb sizes.

### CROSS-REFERENCE TO RELATED APPPLICATION

This application claims the priority date of provisional application No. 60/756,660, filed Jan. 06, 2006.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention generally relates to wrist watches, and more particularly to an improved watch designed for runners and other athletes.

In a conventional wrist watch, the watchcase comprising the display rests on the back side of the wrist, such that when a user want to view the time, the user must turn hand. Also when the user is wearing a long-sleeved garment, it is necessary for the user to push back the sleeve in order to view the display of the watch or to operate the control buttons. For people engaged in sports; such as runners, cyclists, or even skiers, this operation is likely to interfere with performing the sport, and can lead to accidents due to distraction.

Several watches for people engaged in sports have been developed in art. U.S. Pub. No. 20060126446 to Martens et. al discloses a watch assembly that comprises a case housing the watch mechanism and the display screen, actuator means for actuating the mechanism external to the case and connected to the mechanism by connection means, and a wristlet supporting the actuator means, the connection means, and the case, which case is placed on the back of the hand. The wristlet comprises a flexible piece comprising a proximal portion for surrounding the wrist, a distal portion for surrounding at least the first phalanx at the base of the index finger, and an intermediate portion for extending over the back of the hand between said proximal and distal portions and supporting the case. At least one actuator means is mounted laterally on the distal portion of the wristlet so as to be actuatable by the thumb of the same hand.

U.S. Pat. No. 6,519,207 to Lukacsko discloses an all-weather watch to be worn on the outside of one of the heavy-duty gloves of a glove wearer, such as a skier, snow boarder, hunter or motorcyclist, in cold and/or inclement weather. A length-adjustable elastic strap comprises a front strap portion which extends from the watch case and stretches to loop about at least one glove finger. A rear strap portion extends from the case and stretches outwardly to loop about the glove wrist to position the watch on the back of the glove. The rear strap portion is maintained in position by the stretching of the elastic strap, the friction between the strap and the glove and by the cinching action of the loop around the glove wrist, thus not requiring the use of a clasp or other fastener. This enables the watch to be readily removable from the glove by grasping the rear loop and stretching it to move over the glove body and thumb. Putting on and removing the watch can easily be performed by the wearer's other gloved hand.

In U.S. Pat. No. 4,731,766 to Bunyea a combination ski pole handle with a hand-operated watch or timing device mounted therein is disclosed, including a molded hand grip for mounting on the top end of a ski pole, a watch protectively mounted within the hand grip thereof and disposed on a rearwardly sloping top portion thereof to be easily viewable by the skier with the ski pole disposed in near vertical fashion which includes a timing function, and a finger-actuated trigger mechanism for controlling the timing function of the watch.

The above referenced watches require the user to turn hand to view the display of the watch. It is therefore an object of the present invention to provide a watch whose watchcase rests on the knuckle of the thumb of a user, so that the display can be viewed without turning the hand, especially while running. Other objects of the present invention will become better understood with reference to the appended Summary, Description, and Claims.

### SUMMARY

The present invention is an improved watch especially for runners. The watch comprises a watchcase, a wrist loop and a thumb loop. The watchcase includes a display panel for viewing the time and control means for adjusting the time. The wrist and thumb loop extend from opposite sides of the watchcase. The loops are made of flexible material and can be adjusted for accommodating different wrist and thumb sizes.

In order to wear the watch, the user's hand is inserted into the wrist loop, and the user's thumb is inserted into the thumb loop. The watchcase rests on the knuckle of the thumb, providing visibility of the display at all times without forcing a user to turn hand to view the display while running.

### BRIEF DESCRIPTION OF THE FIGURES

FIG. 1 is a plan view of the watch in accordance with the present invention.

FIG. 2 is a perspective view of the watch as the hand of a user is inserted into the wrist loop.

FIG. 3 is a perspective view of the watch as the thumb of the user is being inserted into the thumb loop.

FIGS. 4 and 5 are perspective views of the watch worn on the hand.

FIG. 6 is a perspective view of an alternate way of wearing the watch.

### FIGURES—REFERENCE NUMERALS

10 . . . Watch
11 . . . Watchcase
12 . . . Front Loop-like Member
13 . . . Rear Loop-like Member
14 . . . Display Panel
15 . . . Control Button
16 . . . Hand
17 . . . Thumb
18 . . . Middle Finger

### DETAILED DESCRIPTION

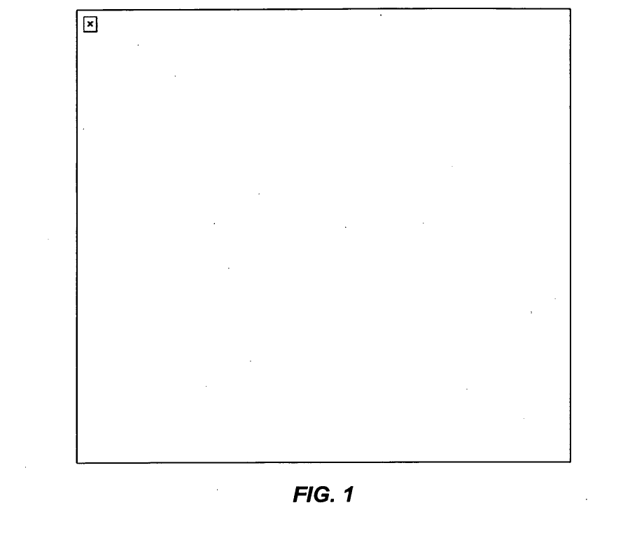

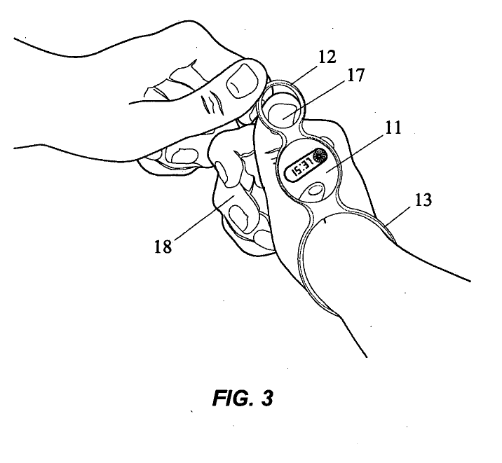

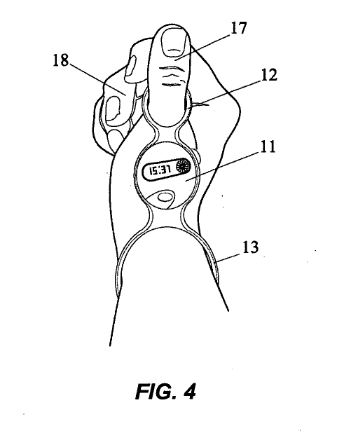

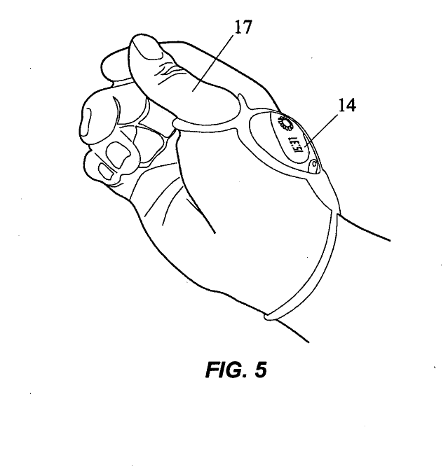

Referring to the drawings, a preferred embodiment of a wrist watch is illustrated and generally indicated as 10 in FIGS. 1 through 5. The present invention is an improved watch 10 designed especially for runners. While wearing a typical wristwatch, a user needs to turn hand to check the time. This action may be inconvenient and distracting to the user, particularly while running. The watch 10 of the present invention enables the users to check the time readily without any difficulty, while performing a variety of running activities.

Referring to FIG. 1, the watch 10 is a sectional timepiece comprising a watchcase 11 and two loop-like members; namely a thumb loop 12 and a wrist loop 13. The watchcase 11 houses the necessary watch mechanism, a display 14 for displaying time, date, chronograph data, etc., and control button(s) 15 for adjusting the clock settings. The wrist loop 13 and thumb loop 12 are disposed in a diametrically opposite configuration, and extend from either side of the watchcase 11. The thumb loop 12 is designed to accommodate the thumb of a user and the wrist loop 13, being larger in diameter than the thumb loop 12, is designed to accommodate the wrist of the user. The wrist loop 13 and thumb loop 12 are made up of a flexible material comprising rubber, plastic, or the like. The two loops are adjustable to accommodate for various wrists and thumb sizes. In one preferred embodiment, the watchcase 11 is turned off center in a counter clockwise direction at 5 to 15 degrees to facilitate visibility display 14 of the while the watch 10 is worn by a user.

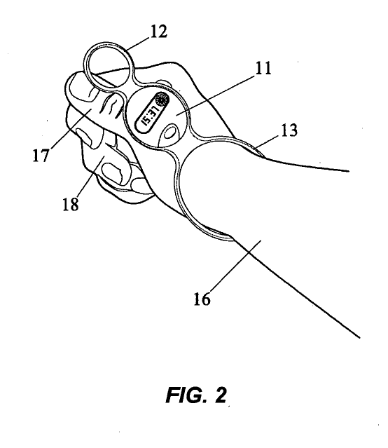

Referring to FIGS. 2 through 5, for wearing the watch 10, initially the user's hand 16 is inserted into the wrist loop 13 and the watch 10 is positioned such. that the watchcase 11 rests on the knuckle of the thumb 17, more specifically, the backside of the watchcase 12 abuts the knuckle of the thumb 17. Then, the thumb 17 is inserted into the thumb loop 12. Following which, the watch 10 is adjusted for comfort.

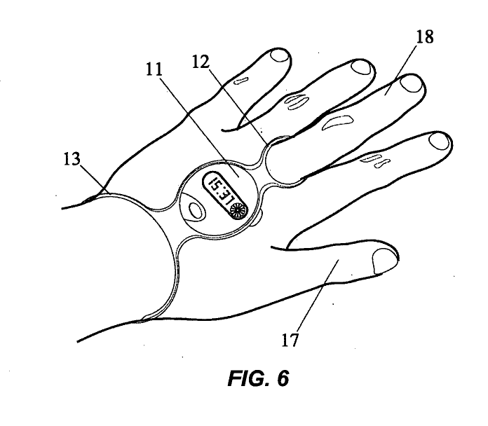

Referring to FIG. 6, the user can alternately wear the watch to middle finger 18 instead of the thumb 17 such that the watchcase rests on the area of the hand behind the palm of a user. This method of wearing the watch 10 will help in providing full visibility of the display panel to a user riding a motorbike, cycle, or the like.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An improved watch for sports personnel, comprising:
(a) a case housing watch mechanism, a display and control buttons;
(b) a wrist loop extending from the case; and
(c) a thumb loop extending from the case, opposite the wrist loop, wherein, when the watch worn by a user, the case will rest on the knuckle of the thumb, thereby allowing the user to view the display without turning hand.

2. The watch of claim 1, wherein the display is angularly tilted to facilitate better view.

3. The watch of claim 2, wherein the display is turned about its central axis perpendicular to the plane of the case, in counter clockwise direction at an angle of 5 to 15 degrees.

4. The watch of claim 1, wherein the wrist loop and the thumb loop are made of flexible material comprising rubber, plastic or leather.

5. The watch of claim 1, wherein the thumb loop is configured to surround only the joint of proximal phalanx of the thumb and the palm.

6. The watch of claim 1, wherein the wrist loop and the thumb loop are adjustable to accommodate various wrist and thumb sizes, respectively.

7. The watch of claim 6, wherein the wrist loop and the thumb loop are elastic so as to accommodate various wrist and thumb sizes, respectively.

8. The watch of claim 1, wherein the thumb loop is used to receive any other finger to wear the watch, with the case resting behind the palm.

9. The watch of claim 1, wherein the watch is flat, with the case, wrist loop and the thumb loop lying in same plane.

10. The watch of claim 1, wherein the control buttons are located on the top and side portion of the case.

11. The watch of claim 1, wherein the case comprises a circular shape.

12. An improved watch for sports personnel, comprising:
(a) a case housing watch mechanism, a display and control buttons;
(b) a flexible wrist loop; and
(c) a flexible thumb loop extending from the case opposite the wrist loop, wherein the case, the wrist loop and the thumb loop lie in same plane and, when the watch is worn by a user, the backside of the case will abut the knuckle of thumb to allow the user to view the display without turning hand.

13. The watch of claim 12, wherein the display is turned about its central axis
perpendicular to the plane of the case, in counter clockwise direction at an angle of 5 to 15 degrees.

14. The watch of claim 12, wherein the wrist loop and the thumb loop are made of flexible material comprising rubber, plastic or leather.

15. The watch of claim 12, wherein the wrist loop and the thumb loop are elastic, so as to accommodate various wrist and thumb sizes.

16. The watch of claim 12, wherein the control buttons are located on the top and side portion of the case.
